(19) United States
(12) Patent Application Publication
(10) Pub. No.: US 2012/0143677 A1
(43) Pub. Date: Jun. 7, 2012

(54) Discoverability Using Behavioral Data

(75) Inventors: John Bruno, Snoqualmie, WA (US); Joseph Futty, Sammamish, WA (US); Miller T. Abel, Mercer Island, WA (US); Kamran Rajabi Zargahi, Seattle, WA (US)

(73) Assignee: MICROSOFT CORPORATION, Redmond, WA (US)

(21) Appl. No.: 12/960,263

(22) Filed: Dec. 3, 2010

(51) Int. Cl. G06Q 30/00; G06F 15/16

(52) U.S. Cl. 705/14.46; 709/224; 705/14.54; 705/1.1

(57) ABSTRACT

The present disclosure describes a system and method of increasing discoverability of software applications in a marketplace catalog via behavioral data. Specifically, a client monitors behavioral usage of applications with a local usage tracking framework, optionally utilizing a data template. The data is aggregated either on the client or on a server or both, and synchronized with a server storage to be made available via application behavioral services. The client may also host an advertising placement framework to place selected advertising in the view of the client's user. Application behavioral services may apply one or more behavioral algorithms to the aggregated behavioral usage, to generate recommendations to maximize marketplace catalog ranking, visibility and projected revenue.

### BACKGROUND

Presently, software applications may be purchased on-line via web based marketplace catalogs, often hosted within application stores. Application stores typically allow users to search for applications, purchase applications, download and install applications. More advanced applications stores also provide options for users to provide commentary and ranking data on the applications available in the marketplace catalog. In combination with search, commentary and ranking data provide users a way to discover software for purchase.

Marketplace catalogs allow a single point of entry for users to search for applications to purchase. Accordingly, marketplaces catalogs provided a unified and safe alternative to searching the web at large for applications, each seller web site potentially with a different payment and fulfillment system, and each web site potentially a non-secure site. In effect, marketplace catalogs provide a level of assurances to end users that those selling application and content in the marketplace catalog are not malicious. This assurance increases the number of users likely to buy from the marketplace catalog. Large marketplace catalogs currently host tens of thousands of applications and are expected to keep growing.

Marketplace catalogs have provided both advantages and disadvantages for application developers. Marketplace catalogs provide application developers a single place by which to distribute applications, reducing distribution costs and to increase access to disparate potential buyers. Commentary features in the associated application stores provide customer feedback that may be handled in bug fixes and subsequent versions. In this way, marketplace catalogs are a facilitating mechanism to build relationships and dialog with customers. The more customers impact change in applications, the closer the customers will feel to the vendors, and the more likely customers are to make additional purchases from that vendor.

However, due to the large number of applications in the marketplace catalog, application discoverability is reduced. It is not unusual for an application to be hard for a user to discover despite excellent commentary and rankings.

Some efforts have been made to add usage data to distinguish applications with similar rankings. Usage data might include statistics as to which applications are most downloaded, or which applications are most used. There are also manual methods of curation, but such methods do not necessarily have a way to assess whether results reflect the true state of the customer. However, usage data should be contrasted with behavioral data which describes how a user reacts within a given context.

Because commentary and ranking data does not differentiate application feedback from users with different behaviors, an application's commentary and ranking may in fact be lower than if screened by behavioral model. For example, a power user may find a text editor under-featured and give negative feedback; in contrast a casual user may provide application with a high ranking for not having unnecessary features. Conversely, marketplace catalogs and application stores in general do not provide users the ability to search for application via behavioral patterns, and generally do not surface applications to application purchasers based on behavioral data.

Accordingly, application developers have to rely on lowering price as a means to increase likelihood of purchase. The resulting price war is damaging to the application ecosystem and may unnecessarily discourage application developers from creating software. For customers, finding relevant applications is difficult because price no longer necessarily reflects true application value. Thus the customer base may be smaller than the true state of the market.

### BRIEF SUMMARY

This Summary is provided to introduce simplified concepts for improved discoverability using behavioral data, which are further described below in the Detailed Description. This Summary is not intended to identify essential features of the claimed subject matter, nor is it intended for use in determining the scope of the claimed subject matter.

This disclosure relates to improved discoverability using behavioral data. Specifically, this disclosure relates to changing application attributes based on behavioral analysis of user data in order to surface applications to likely purchasers, or to increase the likelihood of purchase.

An example of application attributes may include price points. The price that a potential purchaser is willing to pay for an application may vary over time. By performing statistical and behavioral analysis on a particular user, on a particular user's group such as a set of friends in a social network, or on all users, embodiments described herein may provide a price or price curve over time recommendation to application developers.

Another example of an application attribute is a list of other applications to be associated with during purchase. Specifically, embodiments described herein may perform behavioral analysis to determine that purchasers of a particular video game typically purchase a graphics enhancement package. When users search for that particular video game in a marketplace catalog, the marketplace catalog may surface the graphics enhancement package along with the video game. Note that surfacing applications need not be limited to marketplace catalogs. Based on the same behavior analysis regarding users of the video game, an advertisement server may target graphics enhancement package advertising to individuals using the video game.

Generally, improved discoverability using behavioral data includes collecting application behavioral usage data on a client, perhaps as directed using a data template, and subsequently with a behavioral service performing behavioral analysis and providing recommendations to application developers on how to increase the likelihood that a user will discover an application in an application store.

For example, a user may make use of text editor on a smart phone. A data template may direct a usage tracking framework to track usage of hotkeys by users. A behavioral algorithm on the behavioral service may then discover that users with smart phones with slide out keyboard rank the text editor is ranked higher than users with smart phones equipped only with touch screens. The behavioral service may then recommend that the application developer associate the key phrase “hot-key friendly” in the marketplace catalog. In this way, a user who happens to be on a phone using a keyboard and happens to be using hotkeys, and is searching for a text editor might have the marketplace catalog surface the text editor associated with those key phrases. Note that the user need no enter “hot-key friendly” as a key phrase, but rather the marketplace catalog could adapt its behavior based on its understanding of the user's behavior.

In another example, an application developer may be planning a future product. Searching the behavioral service, the application developer may discover that there are a large number of text editors. But instead of abandoning the field, the application developer may discover that a large class of text editor users shift context from the editor and back and forth from web sites. The developer may further discover that users are using the text editor as a better editor than the form editors on some web pages. Subsequently the developer may decide to developer a feature to create a hotkey to cut and paste the contents of the text editor to the active field of a web page.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a top level diagram of an illustrative operational flow of the application behavioral services.

FIG. 2 is a hardware diagram of an exemplary hardware environment for application behavioral services.

FIG. 3 illustrates an architectural block diagram of the client side framework, application behavioral services and surrounding context.

FIG. 4 illustrates an exemplary data template utilized by the application behavioral services.

FIG. 5 is a flow diagram of an illustrative operation of the client side of the application behavioral services.

FIG. 6 is a flow diagram of an illustrative operation of the server side of the application behavioral services.

### DETAILED DESCRIPTION

### Overview

As noted above, users and application developers do not have access to behavioral data about applications. As a result, it is difficult to discover applications that support application behavioral patterns that best meet a user's needs. Furthermore, it is difficult for application developers to discern features to address the needs of underserved behavioral patterns. Moreover, application developers do not have the ability to change application attributes in marketplace catalogs based on behavioral data in order to increase ranking or likelihood of purchase.

This application discloses improved discoverability using behavioral data. Specifically, this application discloses methods and systems for application behavior services. Embodiments disclosed in this application include, but are not limited to collecting application behavioral usage data on the client, aggregating the collected usage data, and trending, recommendation, pricing and advertising services based upon behavioral analysis of the aggregated usage data.

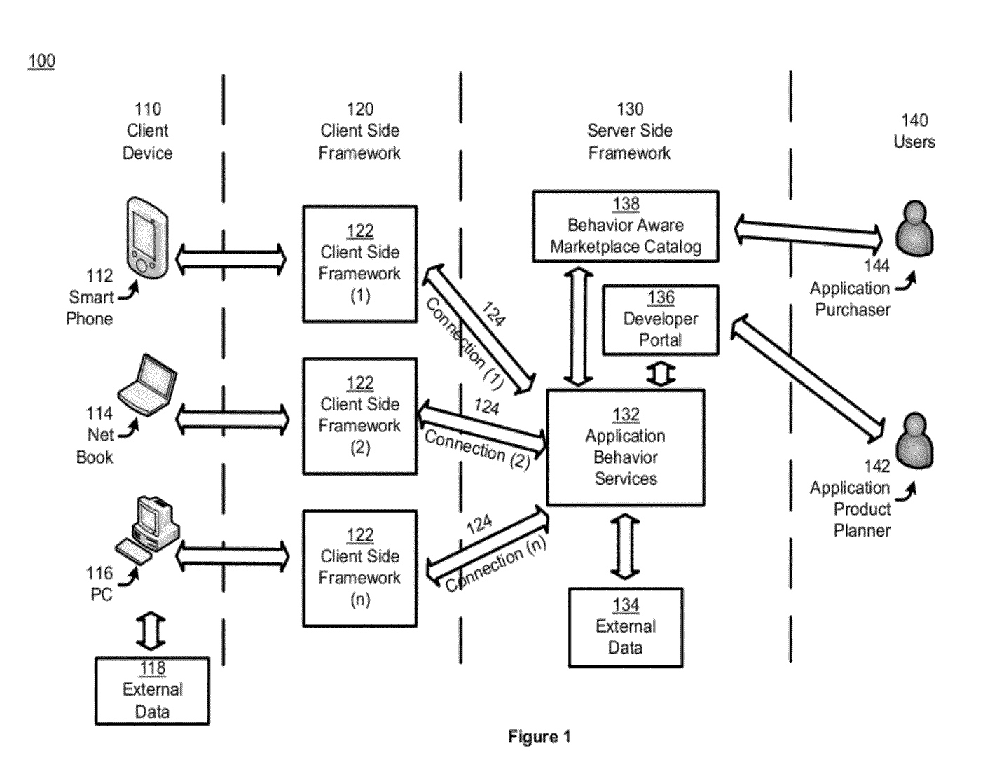

FIG. 1 illustrates an operational flow for the behavioral services 100. Client devices 110 have locally executing client side frameworks 120 that monitor usage behavior of applications. The client side frameworks 120 provide data that is aggregated via server side framework 130. Users 140 access the aggregated data on the server side framework 130 to make decisions.

Client devices 110 broadly include any device that can run a software application. Client devices 110 include, but are not limited to mobile devices such as smart phones 112 and net books 114. They may include laptops, tablet personal computers and mobile pad devices as well. Client devices 110 also include non-mobile devices such as personal computers 116. Client devices run software applications and operating systems (not shown). Client devices may also access external data 118 including, but not limited to personal data and social network data such as data from a user's Facebook™, Twitter™ or LinkedIn™ account.

Each client device 110 runs its own client side framework 120 (see item 122 instances 1 through n respectively) locally. When an application or operating system function executes on a client device 110, its respective client framework 122 monitors behavioral usage. Note that because an operating system arbitrates activity between different applications, cross application behavioral usage data may also be collected. The client side framework 122 may also collect non-application data such as external data 118.

Each client side framework 122 may aggregate behavioral data locally, or alternatively upload data to a server for remote aggregation. For either option, data uploading may be performed via connection 124. Connection 124 may be wireless such as via cell phone protocols including, but not limited to Cell Division Multiple Access (CDMA), Time Division Multiple Access (TDMA), Frequency Division Multiple Access (FDMA) or their successors. Alternatively, both wired and wireless IEEE 802 standards (e.g. Ethernet or Wi-Fi) may be used to communicate with server side framework 130.

Server side framework 130 comprises the application behavior services 132 which perform behavioral analysis on aggregated data from client devices 110 via client side frameworks 120. The aggregated data from client devices 110 may be supplemented via external data 134 including, but not limited to, idealized statistical models and marketplace data. The behavioral analysis may provide trend analysis, pricing analysis and advertising analysis.

Server side framework 130 includes access points for the behavioral analysis and the aggregated data. Examples include, but are not limited to a developer portal 136 web site or application to assist in application product planning, and a behavior aware marketplace catalog 138, potentially integrated with an application store. While other marketplace catalogs may exist, behavior aware marketplace catalog 138 allows users to search based on behaviors, and for application developers to increase the likelihood of purchase based on behavioral data. An example is to use behavioral data to improve an application's ranking and visibility. For instance, the marketplace catalog 138 may affirmatively surface applications to potential purchasers based on behavioral analysis. If the marketplace catalog 138 is accessed via a user 140 that is known via the application behavior services 132 to tweet about celebrities or accesses many celebrity news web pages, the marketplace catalog may affirmatively display a “Hollywood Star Tracker” mobile application for potential purchase. Alternatively, the client side framework 122 may include advertising services which affirmatively place advertisements for the “Hollywood Star Tracker” application on the user's smart phone 112.

Typical users 140 include, but are not limited to application developers or application product planners 142 via the developer portal 136 and application purchasers 144, via the behavior aware marketplace catalog 138.

Exemplary scenarios for access to application behavioral services for application purchasers 144 via the behavior aware marketplace catalog 138 include both explicit and implicit capabilities. An application purchaser 144 may explicitly search for applications in the marketplace catalog 138 by including behavioral terms as part of their search criteria. The marketplace catalog 138 may in turn modify its behavior to a user based on behavioral data. For example, if a user is known to use Twitter right after purchasing movie tickets, the marketplace catalog may display a window of “Applications You Might Like” where the displayed applications are selected from applications commonly downloaded by other users with similar behaviors.

Similarly application product planners 142 may retrieve behavioral data from the developer portal 136 to identify features for future versions of applications or to identify opportunities for new applications. The Developer portal 136 may offer recommendations on how to position the application in marketing including, but not limited to recommendations for pricing, advertising, and tagging to increase marketplace catalog ranking and visibility. By way of another example, Application product planners 142 may use information from the developer portal 136 to obtain recommendations on how to modify the application's marketplace catalog ranking and visibility.

### Exemplary Hardware Environment

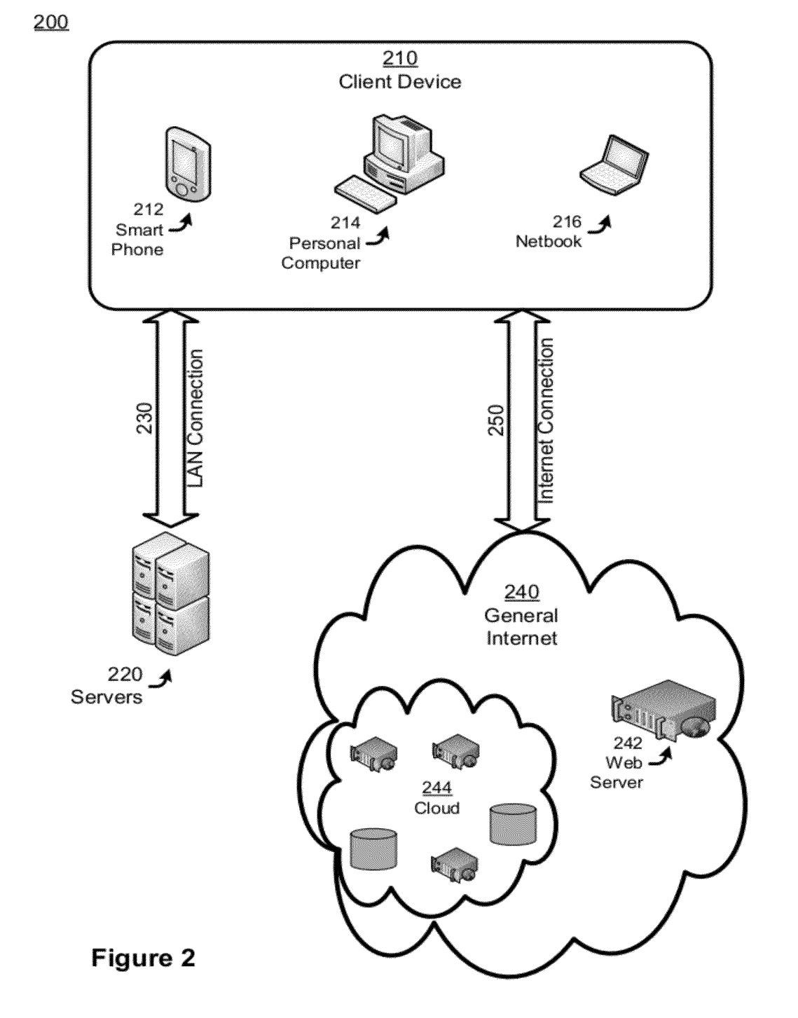

FIG. 2 illustrates an exemplary hardware environment 200 for application behavioral services.

The application behavioral services client frameworks are capable of being hosted on a wide range of client devices 210. Client devices 210 may be any client that runs applications including, but not limited to a smart phone 212, personal computer (“PC”) 214, or netbook 216. PC 214 may include any device of the standard PC architecture, or may include alternative personal computers such as the Macintosh™ from Apple Computer, or workstations including but not limited to UNIX workstations. Client devices 210 not shown may include notebook PCs and pad devices.

Client frameworks for application behavioral services on a client device 210 that have network capability may then access application servers hosted on a server 220 or a server hosted on the general internet 240.

If a client framework for application behavioral services is accessing a server 220 on a local area network (“LAN”), it may connect via any number of LAN connectivity configurations 230. At the physical layer this may include Ethernet or Wi-Fi. At the network/session/transport layer this may include connectivity via the Transmission Control Protocol/Internet Protocol (“TCP/IP”) or other protocol. If the client framework for application behavioral services is accessing the internet, it may connect via standard internet protocols including TCP/IP for the network/session/transport layer and Hypertext Transfer Protocol (“HTTP”) at the application layer.

Client devices 210 that do not have network capability may share data with application servers or other machines via transferring memory cards such as SD memory cards or thumb drives, or via a wired connectivity such as universal serial bus (USB).

Server 220 may be based on a standard PC architecture, or on a mainframe.

If accessing the general internet 240, an independently hosted web server 242 may be accessed. A web server 242 may be a standard server based on a standard PC architecture that hosts an application server. Exemplary application server software includes Internet Information Server (“IIS”) from Microsoft Corporation or Apache Web Server, an open source application server. Web server 242 may access a database server also potentially on a standard PC architecture hosting a database. Exemplary databases include, Microsoft SQL Server™ and Oracle. In this way an application behavioral services may run on both 2-tier and 3-tier platforms.

Alternatively, application behavioral services server infrastructure may be hosted on a cloud computing service 244. Cloud computing service 244 contains a large number of servers and other computing assets potentially in geographically disparate locations. These computing assets may be disaggregated into their constituent CPUs, memory, long term storage, and other component computing assets. Accordingly, the metadata association process, the search engine, and a digital media object data store, when hosted on cloud computing service 244, would have both centralized and distributed data storage on the cloud, accessible via a data access API such as Open Database Connectivity (“ODBC”) or ADO.Net from Microsoft Corporation. Application behavioral services would be hosted on computing assets in the cloud computing service 244 corresponding to an application server.

Client devices 210, enterprise servers 220 and web servers 242 may all support both on-board and removable computer-readable media. Computer-readable media includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

### Exemplary Architecture of the Embodiments

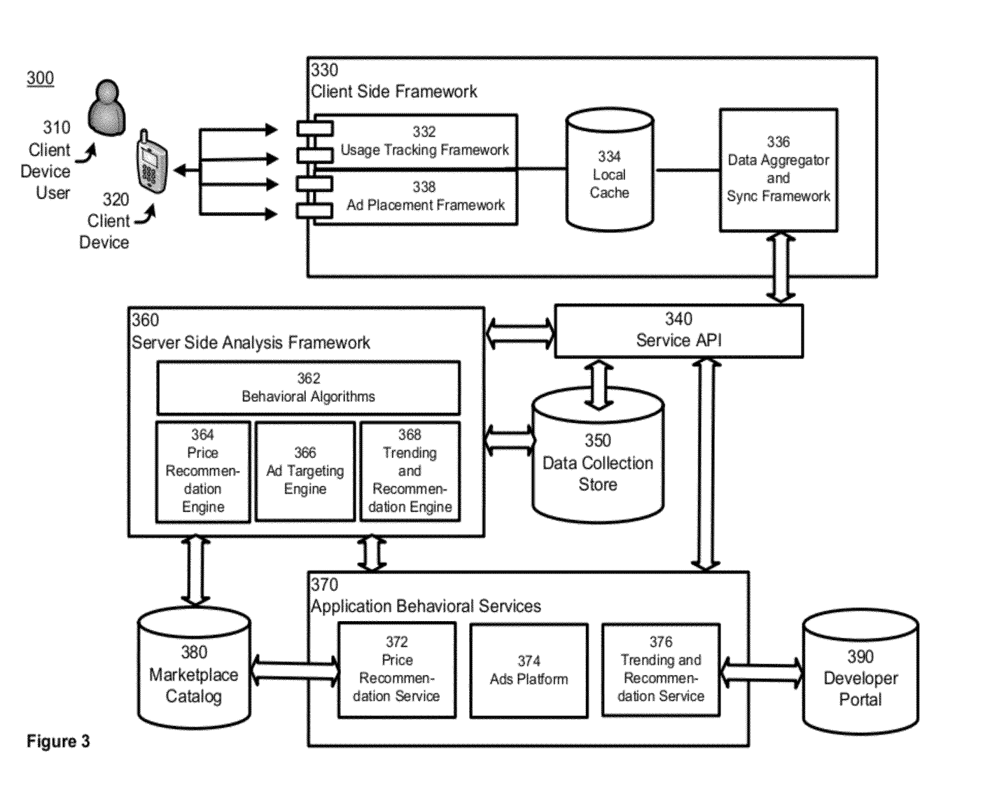

FIG. 3 expands upon FIG. 1's client side framework 120 the server side framework 130 and surrounding context. Specifically, FIG. 3 is an exemplary block architectural diagram of the behavioral services 300.

FIG. 3's client device user 310 and client device 320 may correspond to the client devices 110 in FIG. 1. Similarly, FIG. 3's client side framework 330 may correspond to the client side framework 120 is FIG. 1. Client device user 310 may configure client device 320 to run client side framework 330 to monitor application and/or operating system usage. Client device user 310 may opt out of using the client side framework 330, such that the client side framework 330 does not monitor application and/or operating system usage. A client device 320 may potentially have multiple different client device users 310 and a client user 310 may potentially use multiple client devices 320.

Client side framework 330 comprises several sub-frameworks. Usage tracking framework 332 comprises a software module that tracks an application or operating system action. This may be performed in several way including, but not limited to trampoline functions, journaling hooks, and application monitoring application programming interfaces (APIs) exposed by the operating system. Examples of such monitoring APIs include, but are not limited to Event Tracing for Windows™ (ETW) and Windows Monitoring Interface (WMI) in the Microsoft Windows™ operating system. Usage tracking framework 332 may use these, or similar facilities to track application behavioral tracking data including, but not limited to the identity of the user, the identity of the application or operating system function, the context of the tracked application or operating system action, and to obtain any parameter values associated with the context or the tracked application or operating system action. For example, if a user were to enter text into a text box, an associated parameter value might be the entered text, and a context value might be the window title of the form, and an application identity might be the executable name of a web browser. By way of another example, if a user operating system action were to switch from a text editor to a browser, the associated parameter values might be the executable names of the text editor and of the browser, a context value might be the name of the active window in the text browser, and the application identity might be the executable name of the operating system.

Once captured, application behavioral usage tracking data may be locally stored, for example in a local cache 334. Local storage may be come in any number of forms including, but not limited to Flash Memory, and local hard drives. The local storage need not be temporary cache, but optionally may be a long term persistent file.

After storage, the stored application behavioral usage tracking data may be aggregated. In FIG. 3 the aggregation is performed locally on the client device 320 in a data aggregator and synchronization framework 236.

In one embodiment, the data aggregator and synchronization framework 336 may include apply aggregation directives on how to extract desired behavioral data from the initially captured application behavioral usage tracking data. For example an aggregation directive may direct the data aggregator and synchronization framework 336 to identify all instances in the initial application behavioral usage tracking data where a user switched from a text editor to a web browser. Another example of an aggregation directive might be to identify all instances where hotkeys were used in a text editor. Upon identification of the instances as directed by the aggregation directive, the data aggregator and synchronization framework 336 may upload the aggregated data to a server. The upload action may be done affirmatively by the data aggregator and synchronization framework 336, or alternatively done upon receiving a request from a server. Accordingly, the data aggregator and synchronization framework 336 supports both push and pull protocols.

In another embodiment, the data aggregator and synchronization framework 336 need not identify all instances of a particular application behavioral usage. For example, where an application is programmed to affirmatively access the usage tracking framework 332, the application may apply additional logic to select particular instances of application behavioral usage for the data aggregator and synchronization framework 336 to track.

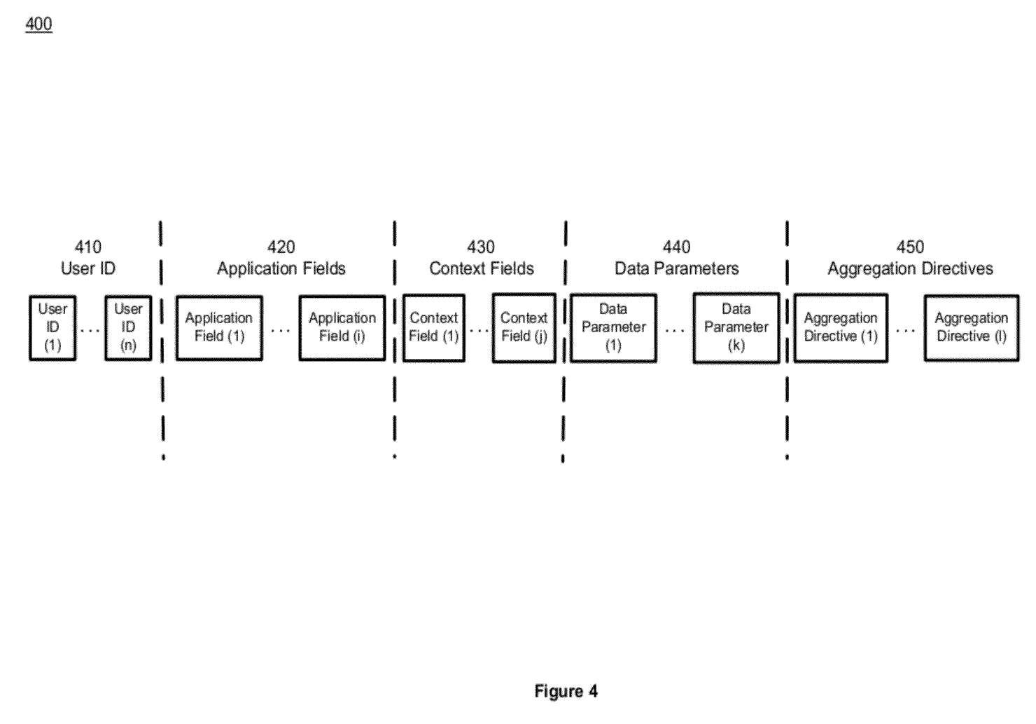

Data aggregator and synchronization framework 336 may make use of a data template which specifies the application behavioral usage tracking data and aggregation directives. The data template is discussed in further detail with respect to FIG. 4. Alternatively, an application on the client device 320 may affirmatively store application behavioral usage tracking data by programmatically invoking the data aggregator and synchronization framework 336 via an API.

In FIG. 3, data aggregator and synchronization framework 336 is shown as executing on the client device 320. However, in alternative embodiments, the data aggregator and synchronization framework 336 may execute partially or fully on a server.

The client side framework 330 may also comprise additional frameworks including, but not limited to an advertising placement framework 338. An additional framework may make use of the application behavioral usage tracking data as aggregated according to aggregation directives by the data aggregator and synchronization framework 336 and server side sources. For example, an advertising placement framework might make use of aggregated application behavioral data to select and place advertising. In the case of a game, articles for in play purchase may be selected based at least in part on the aggregated application behavioral data. Similarly, in browser advertisements may be based at least in part on the aggregated application behavioral data. The advertising placement framework 338 may also provide additional application tracking facilities including click through tracking and purchase tracking. Applications may affirmatively invoke the advertising placement framework 338 programmatically via an API. Other additional frameworks, such as a framework to enable custom features in applications or a framework to customize the look and feel of the client device 320 may make decisions based at least in part on the aggregated application behavioral data. Similarly, such additional frameworks may invoke the data aggregator and synchronization framework 336 programmatically via an API.

FIG. 3's service API 340, data collection store 350, server side analysis framework 360, and application behavioral services 370 comprise the application behavior services 132 of FIG. 1. Service API 340 allows components of the client side framework 330, and application behavioral services 370 to programmatically access data collection store 350 and server side analysis framework 360. Generally, service API 340 provides the interface to data collection store 350 and server side analysis framework 360, but alternative embodiments may allow the server side analysis framework 360 direct access for performance optimization purposes.

Data collection store 350 may be in the form of one or more server hard drives which store application behavioral data uploaded by the data aggregator and synchronization frameworks 336 of one or more client devices 320. The data collection store 350 may be implemented as files in a file system, as a relational database, or alternatively as an application specific persistent file such as a memory mapped file or a persistence file in a custom binary format.

Server side analysis framework 360 comprises one or more behavioral algorithms 362 that may be applied to data aggregated in the data collection store 350. Behavioral algorithms 362 may also access external data including, but not limited to marketplace catalog data 380, to obtain pricing and ranking data for applications. Behavioral algorithms 362 may include for example algorithms that seek correlations between one set of behaviors and another set of behaviors or between one set of behaviors and external data such as rankings within a marketplace catalog 380, or by way of another example, algorithms that detect increasing or decreasing trends in correlations. The behavioral algorithms 362 may also persist results and analyses in data collection store 350 for use by multiple services. Alternatively, the behavioral algorithms 362 may store results locally.

Server side analysis framework 360 further comprises one or more engines (364, 366, and 368) that either programmatically invoke the behavioral algorithms 362 or access results persisted by the behavioral algorithms 362 on data collection store 350. The engines (364, 366, and 368) may be exposed programmatically or to users via corresponding application behavioral services 370. Example server side analysis framework 360 includes, but is not limited to a pricing recommendation engine 364, an advertising targeting engine 366 and a trending and recommendation engine 368. Their corresponding services are the price recommendation engine 372, the advertising platform 374 and the trading and recommendation service 376 respectively.

The pricing recommendation engine 364 and the price recommendation service 372 determine correlations between application behavioral data stored in data collection store #50, and the price potential application purchasers are willing to pay for the application. The price recommendation service 372 may recommend a range of prices based on price recommendation engine 364 findings. Alternatively, the price recommendation engine 364 may calculate a price curve showing how pricing should evolve over time. The pricing recommendation engine 364 may potentially identify marketplace events, such as being featured as most downloaded in a marketplace catalog 380, or being ranked with five stars out of five, and provide pricing recommendations under such circumstances. The pricing recommendation engine 364 and pricing recommendation service 372 may also provide other options such as bundling with other applications.

The advertising targeting engine 366 and advertising platform 374 can provide recommendations on how to maximize advertising revenue based on behavioral data. For example, the advertising target engine 366 may search for correlations between users that have the same behavior and the click through rates for advertising. Where there is a strong correlation, the advertising framework may use the service API 340 to invoke the advertising placement framework 338 to preferentially place advertising based on the correlations. The target engine 366 may consider multiple parameters such as length of time for advertising, length of exposure, placement within an application, cost of placement, and cost of click through. Advertising recommendations are then exposed via the advertising platform 374.

The trending and recommendation engine 368 and the trending and recommendation service 376 identify correlations between behaviors and between behaviors and marketplace catalog data 380. For example the trending and recommendation engine 368 may determine that a particular set of users Tweet after using purchasing concert tickets, and that those users also tend to use a particular social networking game. The trending and recommendation service 376 can provide product planning recommendations and specifically may recommend that additional social networking games similar to the correlated game should be developed. The trending and recommendation service 376 may also be configured to change the marketplace catalog 380, specifically by creating a special section of applications a user might consider. Thus the trending and recommendation engine 368 and trending and recommendation service 376 not only identify recommendations based on behavioral correlations, it can also affirmatively change the behavior of a marketplace catalog 380 based on those behavioral correlations.

FIG. 3's marketplace catalog 380 and developer portal 390 are applications that correspond to FIG. 1's behavior aware marketplace catalog 138 and developer port 136 respectively. Marketplace catalog 380 and developer portal 390 provide access to application purchaser users 144 and application product planners 142 respectively. These applications not only access application behavioral services 370, but may also combine results. For example, a developer portal 390 may combine pricing, advertising and marketplace catalog modifications all into a comprehensive strategy to achieve a certain revenue result. Similarly the marketplace catalog 380 may have both advertisements placed in the marketplace catalog 380 providing a coupon discount code for an application, at the same time the marketplace catalog 380 is modified to bundle the application with another application. Strategies on the client may also be combined with strategies on the marketplace catalog. For example, advertisements for a new version of an application appearing on a marketplace catalog 380 may be combined with in application purchase opportunities on a client device 320 as exposed via the advertising placement framework 338.

### Exemplary Data Template

FIG. 4 illustrates an exemplary data template 400. A data template 400 describes the data to be tracked including, but not limited to one or more user identifiers 410, one or more applications fields 420, one or more context fields 430, one or more data parameters 440 and optionally provides one or more aggregation directives 450.

A data template 400 may be static or dynamically generated. Static data templates 400 may come in the form of formatted text files such as in an extensible market language (XML) format in comma separated value (CSV) format. Alternatively, static data templates 400 may be binary files of a proprietary format. A data template 400 may be encoded in an application and the behavioral data dynamically generated programmatically. Accordingly, a static data template 400 could be dynamically generated, or alternatively a static data template 400 could be bypassed altogether and the behavioral data would be determined based on the encoded specification in the application program itself. In the latter case behavioral data to be stored could dynamically evolve based on application, operating system and contextual conditions.

User identifiers 410 are data fields to track the identity of the user whose behavior is being tracked. These fields account for the possibility that a client device 320 may have multiple users 310 and a user 310 may use multiple client devices 320. Users identified by user identifier 410 need not be human users. For example, a user may be an application process. Users identified by user identifier 410 may be different identities of the same user. For example the same user 310 may have a power user account and an administrator account, where in each role the user 310 exhibits different behaviors.

Applications fields 420 identify the application being monitored. Example application fields 420 include, but are not limited to application executable name, version number, hosting operating system, and hosting device. The application fields 420 may be determined to correspond with an application that might be offered separately for sale on a marketplace. Alternatively, the application fields 420 may provide additional fidelity for application product planners 142 to isolate certain behaviors, for example comparing and contrasting the behavior of users with touchscreens versus users with slide out keyboards.

Context fields 430 describe any environmental conditions the user 310 is experiencing that might be behaviorally correlated with the user's response. Context fields 430 may be within the scope of an application, such as the name of a feature in an application currently being used. Context fields 430 may be that of other applications concurrently being used, such as currently being on a phone call, or currently ordering tickets on another application. Context fields 430 may be that of external data, such as data collected from the user's social network account. Context fields 430 may also include environmental conditions such as geolocation and time of the day. Note that a same field might be stored either as an application field 420 or as a context field 430 depending on the nature of the behavior to be monitored.

Data parameters 440 are values specific to the user's response to a context. For example, if a user enters text into a Twitter™ field, that text may be a data parameter 430. By way of another example, if a user selects a radio button, the value may be a data parameter 430. Data parameters 430 are not limited to user interface control values. Data parameters 430 may identify actions performed, such as switching from one application to another. Data parameters 430 may also comprise dynamically generated data such as an application log.

Aggregation directives 450 are instructions as to how to correlate instances of behavior. Aggregation directives 450 may be in the form of programmatic logic. Alternatively, aggregation directives 450 may be simple collections, such as grouping all behavior instances by user or by some other query selection criteria. Where aggregation directives 450 are specific for client side aggregation activities, the aggregation directives 450 may be optional where the aggregation is to be performed on the server side.

### Exemplary Client Side Operation

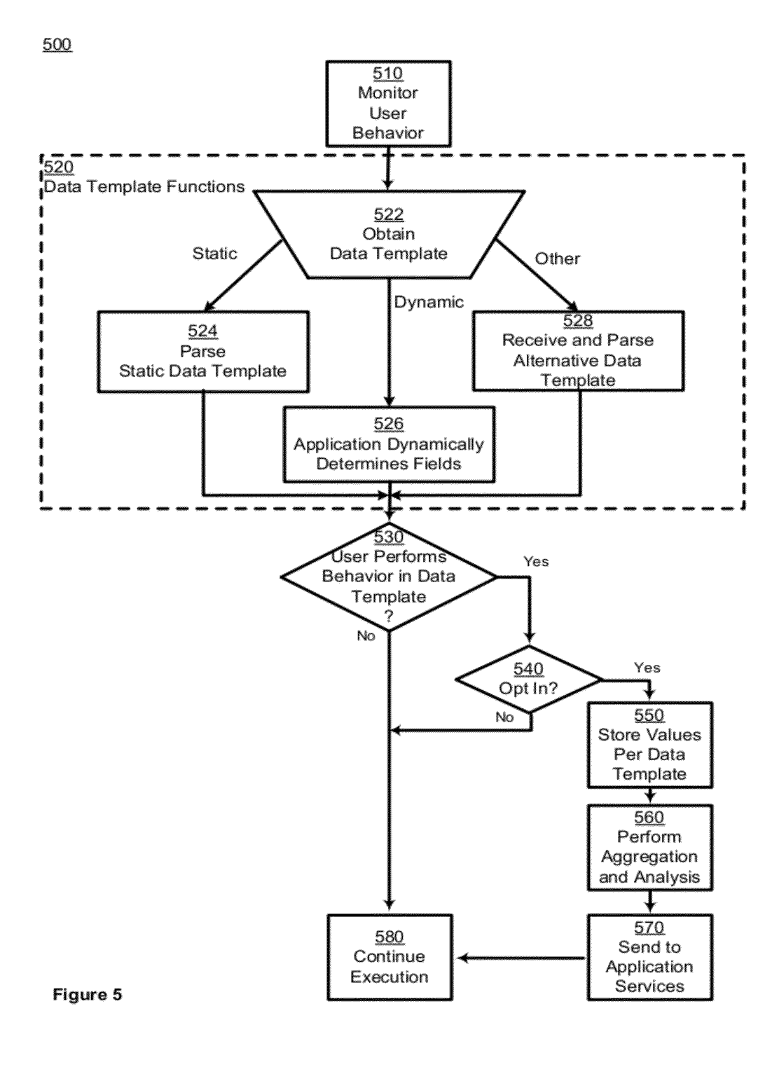

FIG. 5 illustrates an exemplary client side operation 500 of the application behavioral services.

At block 510, the client side framework 330 monitors user behavior. At this point, the client side framework 330 is merely executing, and has not yet been directed to monitor particular behavior. Various mechanisms to monitor behavior are described with respect to item 330 in FIG. 3.

At block 520, the client side framework 330 is directed via a data template as to what behavior to monitor. Specifically, at block 522 the client side framework 330 obtains a data template 400. If the data template 400 is a static file, the data template 400 is parsed at block 524 for constituent fields and directives. Alternatively, if the data template is specified programmatically in an application, there is no data template to parse, and at block 526 the application may dynamically determine which fields to monitor and store and how to aggregate the fields without a physical data template. Another alternative 528, a hybrid of static and dynamic approaches may be used where a physical data template 400 is either downloaded, or programmatically generated. Upon receipt of such a data template 400, the data template 400 is parsed for constituent fields and directives. A client side framework 330 may work with multiple data templates, dynamic or otherwise.

As the user 310 uses client device 320, the user may perform a behavior 530 as specified by a data template, dynamic or otherwise. If the user 310 has enabled behavior tracking, that is if the user 310 has opted into behavior tracking 540, the data template 400 fields including, but not limited to user identification fields 410, application fields 420, context fields 430, and parameter value fields 440 are stored via block 550 as a behavioral instance. In a file implementation, the behavioral instance may be stored as a line item. In a relational database, the behavior instance may be stored as one or more records in a relational schema.

After block 550, in which the client side framework 330 stores values according to the data template 400, execution proceeds to block 560 to perform aggregation and analysis. At block 560, the data aggregator and synchronization framework 336 performs client side aggregations. Specifically if a corresponding data template 400 specifies one or more aggregation directives 450, the data aggregator 336 performs the aggregation 360. The data aggregator 336 may also perform behavioral analysis at block 560. For example, if the data aggregator 336 determines that a user is engaging in a particular behavior that is known to be receptive to a particular advertisement, the data aggregator 336 may direct the advertisement placement framework 338 to display that particular advertisement.

At block 570, the aggregation results may be persisted locally in storage 334 or may be uploaded to application services. As mentioned before, the data aggregator and synchronization framework 336 supports both push and pull protocols.

FIG. 5 shows a linear progression of storing values 550, aggregating 560 and uploading data 570. This progression is not intended to show causality between the blocks. These blocks may be performed in parallel to each other, and in batches. For example, multiple storages 550 may occur prior to an aggregation 560 and multiple aggregations may occur prior to uploading to application services 570.

If the user 310 has opted out without storing 540 or after storing values 550, aggregating 560 and/or uploading data 570 has occurred, execution continues execution 580.

### Exemplary Server Side Operation

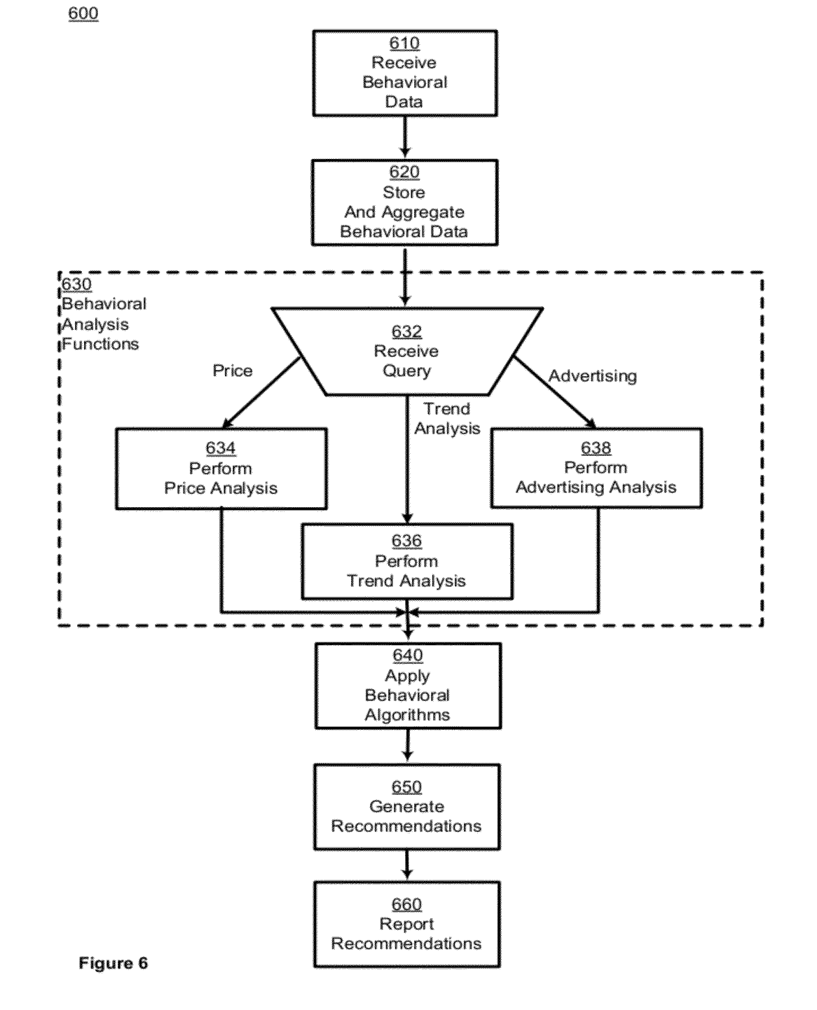

FIG. 6 illustrates an exemplary server side operation 600 of the application behavioral services.

At block 610, client side framework 330 uploads application behavioral data to data collection store 350 via service API 340.

At block 620, the service API functions 340 may directly store the application behavioral data to data collection store 350, or may perform additional aggregation functions. Because the client side framework 330 may aggregate data on the client device 320, operations at block 620 support both storage of aggregated data and unaggregated data. Data may be automatically aggregated according to a data template 400, or may be subjected to aggregation via queries by database operations on the data collection store 350.

Beyond aggregation, at block 620 the service API functions 340 and the server side analysis framework 360 may operate to structure and process the collected data into behavior into behavior information. One possible approach is to create an extensible data schema which provides for the associating collected data with a particular context of interest. For example, the extensible data schema may have an entity to store context and an entity to store application. The two entities could be related together.

An exemplary context might be users that transfer music files from a mobile device to a PC. Another exemplary context might be users that transfer work documents, such as spreadsheets, from a mobile device to a PC. While both contexts relate to file transfer, separating the contexts as two records in a context entity provides additional fidelity to infer user intent.

A context may relate to multiple applications and multiple platforms. Extending the above example, users that transferred music files could be associated with both PC based file transfer applications and Macintosh™ based applications. Similarly, a context record need not distinguish between a user transferring MP3 music files and Advanced Audio Coding (“AAC”) music files. Accordingly, records of user actions could be aggregated by a behavior as opposed to a platform or particular application. Such an extensible schema would provide for identifying relevant applications for a particular behavior.

The extensible data schema need not be limited to context and application entities. Additional entities may include hardware platform and operating system, since application capabilities may vary depending on the hosting device and operating system. The extensible data schema may also support dynamic addition of new entities based on unanticipated forms of behavioral analysis.

The extensible data schema may be implemented various ways. If the data collection store 350 is a relational database, the extensible data schema may be in the form of entities and relations. If the data collection store 350 is a triplestore, then the extensible data schema may be implemented as a resource description framework (“RDF”) schema.

A context entity may be populated either in advance or dynamically. For example, if a developer knew which contexts were to be of interest for an application, the developer may enter those context records of interest at the time the application was submitted to the marketplace catalog 380 or other application store. Alternatively, context records could be added dynamically as the developer learned of new contexts of interest. In some situations, automated routines such as those of the application behavioral services 370 could determine contexts of interest and programmatically add new contexts to track.

At block 630, the application behavioral services 370 may perform behavioral analysis. Specifically, the application behavioral services 370 receive a query on behavioral data 632. Based on the query, the appropriate engine (364, 366 or 368) is invoked to perform analysis. If the query relates to price, the price recommendation engine 364 is invoked. If the query relates to advertising analysis, the advertising targeting engine 366 is invoked. If the query relates to trend analysis, the trending and recommendation engine is invoked. While item 632 is displayed as a selection operation, a particular query may utilize the services of more than one engine (364, 366 or 368).

In the course of executing behavioral analysis, at block 640, the engines (364, 366 or 368) may apply one or more behavioral algorithms 362 to the application behavioral data stored in data collection store 350. While FIG. 6 shows behavioral algorithms 362 being executed after engine (364, 366 or 368) invocations, in some embodiments behavioral algorithms 362 may be executed separately, for example as part of an call from the service API 340. Behavioral algorithms 362 are described in more detail with respect to item 362 in FIG. 3.

After performing behavioral analysis at block 640, the application behavioral services 370 may simply report analysis results, or alternatively generate recommendations at block 650 and report the generated recommendations at block 660.

Recommendations at block 650 may be performed in engines (364, 366 or 368), in the application behavioral services 370, or in applications calling the services such as the developer portal 390. This differs from the behavioral analysis functional in 630 that generally perform in the engines (364, 366 or 368). Recommendations may relate to pricing, advertising, marketplace catalog placement separately or in combinations. Recommendations may be static which provide guidance for a particular point in time, or may provide guidance over an extended period of time.

Recommendation reporting at block 660 covers both static reporting, and dynamic modification of applications. Specifically, where a recommendation is reported statically, the recommendation may come in the form of a screen on an application or web site, or alternatively as a printed report. For example, an application product planner 142 may review the recommendations on an application screen of a developer portal 390, and may perform additional analysis via tools in the developer portal 390 or by exporting the data to third party tools such as a spreadsheet. Alternatively, an application, such as a marketplace catalog 380 may be coupled to the application behavioral services 370, and the recommendations implemented by programmatically accessing the marketplace catalog 380. By way of another example, the application behavioral services 370 may be invoke clients directly, for example via the application placement framework 338 on client device 320.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of application behavioral usage tracking, the method comprising:
monitoring application behavioral usage on a client according to a data template, the data template comprising an application identification field to specify an application, at least one context field to specify an application context, at least one data parameter field, and an aggregation directive;
responsive to the application corresponding to the application identification field executing in a context corresponding to the at least one context field, storing values corresponding to the at least one data parameter field; and
locally aggregating the data parameter stored values according to the aggregation directive in the data template.

2. The method of claim 1, wherein the data template is a static data template, and the method further comprises receiving the static data template.

3. The method of claim 1, wherein the data template is a dynamic data template, and the method further comprises dynamically generating the dynamic data template.

4. The method of claim 1, further comprising transmitting the aggregated data parameter stored values according to a local trigger condition.

5. The method of claim 4, wherein the transmitting the aggregated data parameter stored values is via directly invoking a server side Application Programming Interface (API).

6. The method of claim 1, further comprising receiving a request to transmit the aggregated data parameter stored values, transmitting the aggregated data parameter stored values in response to receiving the request.

7. The method of claim 1, wherein the at least one context field includes non-application data.

8. The method of claim 7, wherein the non-application data comprises social network data.

9. The method of claim 7, wherein the non-application data comprises data about proximate user-community members.

10. The method of claim 1, wherein the storing values corresponding to the at least one data parameter field is conditioned on determining that a user has opted in to application behavioral usage tracking.

11. The method of claim 1, further comprising selecting a data source from multiple data sources for the at least one data parameter field.

12. The method of claim 1, further comprising selecting an advertisement for display on the client, based at least on the aggregated data parameter stored values.

13. The method of claim 11, further comprising receiving input via the advertisement to activate an in-application purchase.

14. A method to perform application behavioral usage trend analysis, the method comprising:
determining application behavioral usage trends for an application with a behavioral algorithm, based at least on usage data parameters collected from one or more client devices according to a data template; and
generating application placement recommendations for application placement parameters maximizing application ranking in marketplace search results.

15. The method of claim 14, wherein the application placement parameters comprise marketplace catalog parameters for an application currently placed in a marketplace catalog.

16. The method of claim 14, wherein the application placement parameters comprise marketplace catalog parameters for an application not yet placed in a marketplace catalog.

17. The method of claim 14, wherein the application placement parameters comprise application price.

18. The method of claim 14, wherein the application placement parameters comprise an application pricing parameter curve over a period of time.

19. The method of claim 14, wherein the application placement parameters comprise parameters to maximize advertising revenue.

20. A system for optimizing application placement in a marketplace catalog, the system comprising:
a processor;
a storage communicatively coupled to the processor;
aggregated usage data stored in the storage according to a data template;
a behavioral algorithm stored in the storage, to determine behavioral trends in the aggregated usage data; and
a trending engine, configured to be operated by the processor to generate application placement recommendations for optimizing application marketplace catalog placement parameters, by applying the behavioral algorithm to the aggregated usage data.
